(19) United States
(12) Patent Application Publication
(10) Pub. No.: US 2010/0110707 A1
(43) Pub. Date: May 6, 2010

(54) Ultraviolet Lighted Instrument Panel And Display

(75) Inventor: Paul Fredrick Luther Weindorf, Novi, MI (US)

Correspondence Address: DICKINSON WRIGHT PLLC, 1875 Eye Street, NW, Suite 1200, WASHINGTON, DC, 20006, US

(73) Assignee: VISTEON GLOBAL TECHNOLOGIES, INC., Van Buren Township, MI (US)

(21) Appl. No.: 12/264,991

(22) Filed: Nov. 5, 2008

(51) Int. Cl. B60Q 1/26; F21V 9/16

(52) U.S. Cl. 362/489; 362/84

(57) ABSTRACT

An instrument panel, gauge, or display that is selectively lighted with ultraviolet (UV) light.

### BACKGROUND OF THE INVENTION

1. Field of the Invention

The present invention relates to instrument panels and gauges that are selectively lighted with ultraviolet (UV) light.

2. Discussion

Vehicle manufacturers continually strive to differentiate vehicles in the marketplace by providing unique styling and aesthetic features. As part of this differentiation, many manufacturers attempt to provide a unique cockpit look and feel for the operator of the vehicle. As part of this unique look and feel, each vehicle manufacturer attempts to have a differentiate their instrument panels and gauges but have been limited by requirements of space and functionality for the various readouts, gauges, status signals, warning lights, and other required information displays.

Instrument panels and gauges are typically backlighted, which limits design options. More specifically, designers are limited by available space and by the number of gauges, informational displays and status lights to be incorporated. In addition, some designers have attempted to add electronic displays which are not capable of being backlighted or difficult to uniformly backlight, such as in general electrophoretic displays and cholesteric liquid crystal displays, e-paper displays, and interferometric modulator displays. To light such displays, designers have tried to use light pipes surrounding the displays or over the display, but it has been found that these solutions are expensive, consume valuable space behind the backplate and display, difficult to manufacture, and typically do not provide sufficient illumination of the display, much less uniform lighting of the display. Another problem with the use of light pipes and displays is that in some circumstances during use dust may become lodged between the light pipe and display. It is important for instrument panels and especially for displays incorporated into instrument panels to provide sufficient and uniform lighting. In particular for vehicles, it is important that this lighting is substantially uniform and sufficient across different levels of illumination to allow the operator to customize the amount of light produced by the instrument panel.

Therefore, it is desirable to provide an instrument panel and gauges that allow for new styles and functionality and in particular, e-paper types of displays while at the same time providing in low light conditions clearly readable and uniformly lighted instrument panels and displays.

### SUMMARY OF THE INVENTION AND ADVANTAGES

The present invention is directed to an instrument panels and displays within instrument panels for a vehicle that are front lighted without the use of light pipes, and more particularly to instrument panels and electronic displays which are integrally front lighted when UV light is applied and include indicia such as markings, status signals, and warning signals that are invisible under normal visible lighting conditions but illuminate visibly when UV light is applied.

A plurality of nanophosphor particles are applied to the display surface of the instrument panel and/or an electronic display. The nanophosphor particles are configured to not be visible when UV light is not applied and even not be desirable in any patterns or interfere with the underlying display or instrument plane when UV light is applied. Therefore, while the nanophosphor particles sufficiently and uniformly light the display and instrument panel, they are not discernable, except that they have provided a front light illumination for the whole instrument plane, but are especially useful in providing illumination to e-paper types of displays that require front lighting.

At least one UV light source is provided within the instrument panel to front light the nanophosphorus particles. When the nanophosphorus particles are exposed to UV light from the UV light source, the nanophosphorus material illuminates the amount of illumination depends on the amount of nanophosphor particles and the intensity of the UV light. Of course, it is important that the nanophosphor particles do not form any discernable patterns and are not directly discernable by the operator, and that the operator is able to clearly see through the substrate including the nanophosphorus particles to the display surface without distraction.

A transparent member is provided between the user and the UV light source and is configured to block UV light. The blocking of UV light ensures that direct sunlight incident on the backplate does not activate the nanophosphorus particles and protects the operator from UV light produced by the UV light source.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

Other advantages of the present invention will be readily appreciated and more fully understood by reference to the following detailed description when considered in connection with the accompanying drawing wherein:

FIG. 1 shows an exemplary instrument panel using individual and separate gauges and an electronic display on one of the gauges;

FIG. 2 shows an instrument panel including an instrument cluster having an electronic display within the cluster and an electronic display on one of the gauges;

FIG. 3 is an enlarged view of an instrument cluster with a UV lighted display;

FIG. 4 is an exemplary sectional view of an instrument cluster with a UV light source; and

FIG. 5 is an enlarged sectional view of the display identified as V in FIG. 4.

### DETAILED DESCRIPTION OF THE INVENTION

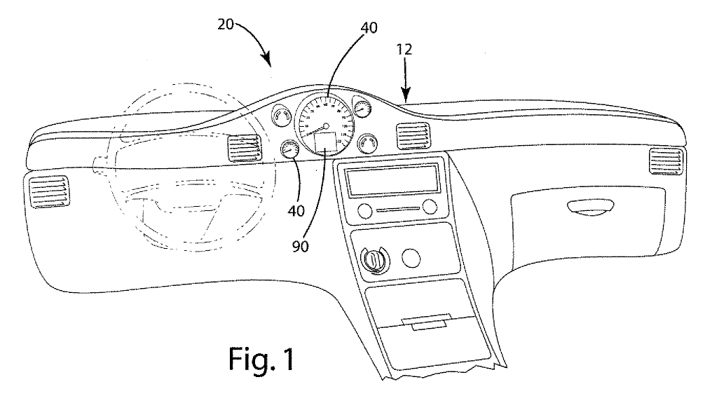

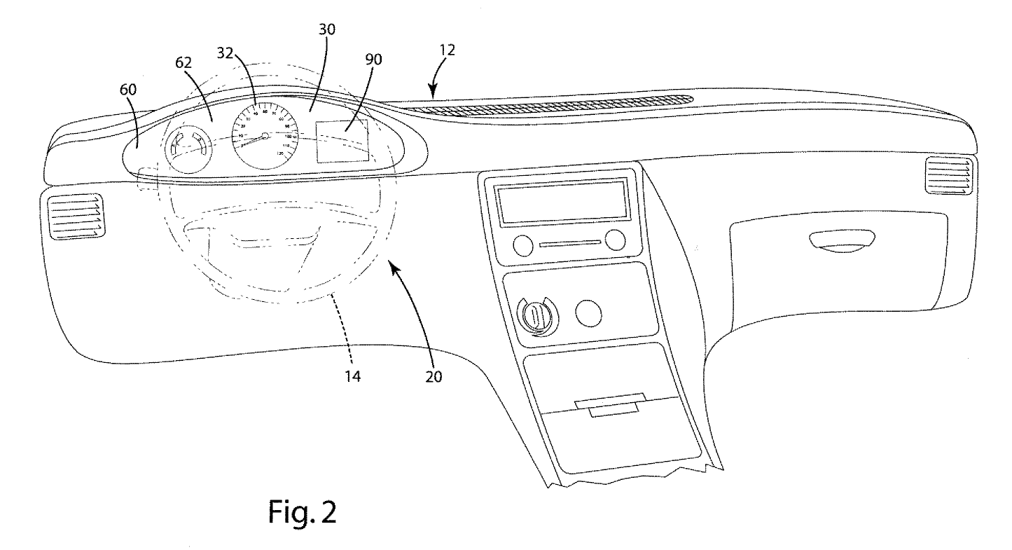

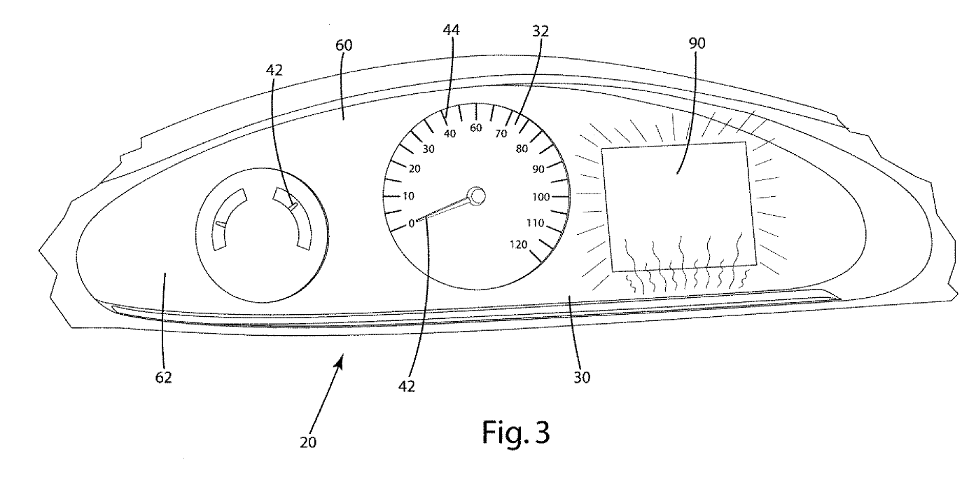

The present invention is generally directed to an instrument panel 20 having a plurality of individual gauges 40 (FIG. 1), at least one of an instrument cluster (FIG. 2), or a combination thereof (not illustrated). Of course, the instrument cluster 30 includes various gauges 32 within the cluster, such as shown on the exemplary single backplate 60. The present invention includes a UV light source 80 and nanophosphor particles applied to the backplate 60. The nanophosphor particles light up or illuminate with visible light in response to UV light from the UV light source. Although the instrument panel 20 is illustrated as being located in the dashboard 12 of the vehicle 12, and particularly applicable to vehicles, the present invention is not limited to vehicles and may be used in a wide variety of settings.

The instrument panel 20 may take on any size, shape or configuration and may vary depending upon the type of the vehicle or other setting into which the instrument panel 20 is installed. Of course, the present invention does not require a complete instrument panel 20 with an instrument cluster (FIG. 2) or multiple gauges (FIG. 1), but may be used within a single gauge 40. As illustrated in FIG. 1, the instrument panel 20 may be made up of a variety of gauges 40 as well as other electronic systems. As further illustrated in FIG. 2, the instrument panel 20 may be formed as a more traditional vehicle instrument panel including an instrument cluster 30 located substantially in front of the steering wheel 14.

The instrument cluster 30 and gauges 40 are generally formed in a similar fashion having a housing 50 which secures and locates a backplate 60 and a transparent plate 70 disposed some distance from the backplate 60. An electronic display may be incorporated into the instrument cluster 30 or gauges 40.

A UV light source 80 is included to cause the nanophosphor particles to illuminate. The backplate 60 may include on the front surface 62 various visible indicia and markings 44. The difference generally between an instrument cluster 30 and gauges 40 is that the instrument cluster 30 includes a plurality of instrument cluster gauges 32 on a single backplate 60, which are similar to the individually housed gauges 40 in FIG. 1. If the instrument panel 20 includes various independent gauges 40, each independent gauge 40 to be lighted with nanophosphor particles would each need at least one UV light source 80. Of course both the gauge 40 and the instrument cluster 30 may include multiple UV light sources 80. The remaining invention shall be generally described below as being applicable to both instrument clusters 30 and gauges 40.

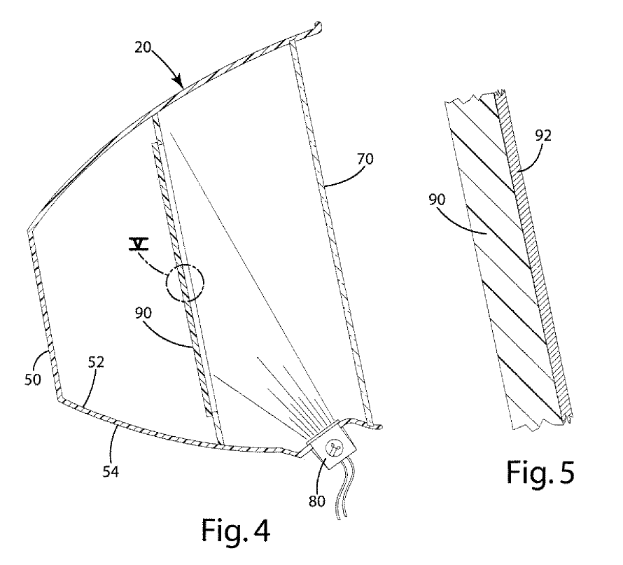

The housing 50 for the gauges 40 or instrument cluster 30 may take on any size, shape or design such as the exemplary housing for the instrument cluster 30 or the exemplary housing for the gauges 40. The housing 50 is illustrated generally in a sectional view in FIG. 4 as locating the backplate 60 a distance from the transparent plate 70. The backplate 60 may include various markings and visible indicia 44 for use in conjunction with pointers 42, to provide information, or provide status signals such as warning lights, turn signals and the like that are visible in visible light without the application of UV light. The housing generally includes walls 54 having inner surface 52 that engages the backplate 60. The housing 50 may be made in any size, shape or configuration. The housing 50 also generally includes a cavity 51 behind the backplate 60 allowing for various electronic and other communication features and the various wiring harnesses (not illustrated).

The backplate 60 has a front or display surface 62 facing the transparent plate 70. The front surface 62 includes the visible indicia and markings 44. The backplate 60 may incorporate an electronic display 64. As stated above, the present invention is particularly applicable to displays that cannot be backlighted or are difficult to uniformly backlight and uses nanophosphor particles to sufficiently and uniformly illuminate the display 90 in low light conditions, without interfering with the clarity of the information on the display 90. The backplate 60 may be made in any size, shape or configuration and may further include translucent portions that allow the status lights behind the backplate 60 to light up various status visible symbols and markings that form the visible indicia 44 to alert or communicate with the operator of the vehicle.

The transparent plate 70 is configured to allow the passage of visible light while blocking the passage of the UV light. The transparent plate 70 may be made in any size, shape or configuration to fit within the gauges 40 or instrument cluster 30. It is important that the transparent plate 70 block UV light to prevent any nanophosphor particles behind the transparent plate from illuminating in response to ambient UV light. For example, in certain conditions the sun may illuminate the backplate 60, which without the transparent plate would cause the nanophosphor particles to illuminate visibly with light in the visible spectrum due to the UV light in sunlight. The transparent plate may be formed from preferably a type of polycarbonate.

The UV light source 80 may be any UV light source capable of causing the UV nanophosphor particles to illuminate or produce visible light viewable by the operator. The UV light source 80 provides ultraviolet light and in some instances, different UV light sources having different wavelengths of ultraviolet light may be used to allow for individually actuated nanophosphor particles to be illuminated in the same instrument cluster 30 or gauge 40. For example, a first group of nanophosphor particles would be responsive to a first UV wavelength, a second group of nanophosphor particles would be responsive to a second UV wavelength, and a third to a third wavelength. This allows the gauges 40 or instrument cluster 30 to illuminate with different colors or when combined to illuminate and provide white light. For example, by providing three different colors of illumination by three different types of nanophosphor particles, an operator could customize the lighting to almost any visible color or white by varying the intensity of the three UV wavelengths. A single UV source 80 may be configured to provide varying amounts of the three wavelengths, or three independent sources may be used. Of course, the color may be set by varying the ratios of the groups of nanophosphor particles during the manufacturing process. Of course, it may be preferable that the nanophosphor particles applied to the surface of any electronic display illuminate with a shade of white. The instrument panel 20 may include different ratios or groups of nanophosphor particles on the surface of the display screen 90 than the backplate 60 surrounding the display screen. Even the surfaces of the gauges 32 may get different ratios. In some circumstances, the nanophosphor particles may be applied only to the surfaces of the gauges 32 and display 90 while the rest of the display surface 62 of the backplate 60 does not include them. This allows selective lighting in response to UV light. Or the ratios of nanophosphor particles, and in some cases included volume may be different between the gauges 32 and remaining display surface 62, such as to allow more illumination of the gauges or colors that vary individually between the gauges and/or between the gauges 32 and the display surface 62.

The nanophosphor particles may be configured to provide different colors. For example, a green emitting phosphor is excited by UV at about 365 nm, red emitting phosphors at about 375 nm and/or 365 nm while blue emitting phosphor is excited at around 405 nm. The nanophosphor particles may be a single color and only responsive to a particular UV source 80, or a blend of different phosphors which allows any desired color. Variation in the shade of color may be made through using different amounts of selected colors of phosphor. Of course, instead of mixing different amounts or intensities of different color emitting phosphor, applying different amounts of UV at a particular wavelength may obtain the same effect. More particularly, as one set of nanophosphor particles has a stronger illumination, the color changes. This allows for ease of manufacturing while allowing for almost any color and even allows for users to customize the colors emitted, for example, instead of a yellow color, the user could customize the color to a reddish purple.

The nanophosphorus particles are not visible on the backplate 60 and any underlying visible indicia 44 may be seen through them. More specifically, the nanophosphorus particles have a size of approximately less than 400 nm and only illuminated but are not individually visible when UV light is applied. By only illuminating when UV light applies allows the nanophosphor particles to be applied over various backlit or front lit visible status signals. The use of nanophosphorus particles applied to the backplate allows these various status signals without visibly detracting from the aesthetic effects of the instrument panel 20 in both normal lighting conditions and when illuminating the instrument plane, or in particular, the display.

The nanophosphorus particles may be applied directly to the backplate or may be incorporated into a film that is applied then directly to the backplate 90 or display. For example, the nanophosphor particles could be applied in a clear paint or other substrate to the backplate 90 or display. In other embodiments, the nanophosphor particles could be printed onto a film and then the film is applied to the backplate 90 or display. In other embodiments, the nanophosphor particles may be embedded or incorporated into a film during the manufacturing process and then applied to the backplate 90 or display. In each embodiment, the nanophosphor particles are secured or coupled to the backplate either directly or indirectly without any substantial gap between the substrate incorporating the nanophosphor particles and the backplate 60. The nanophosphor particles typically form less than 50% and preferably less than 30% by volume of the substrate in which they are incorporated.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. An instrument panel comprising:
a backplate; and
a substrate including nanophosphor particle applied to said backplate and wherein said nanophosphor particles form less than 50% by volume of the substrate.

2. The instrument panel of claim 1 wherein said nanophosphor particles do not form any visible patterns when UV light is not applied.

3. The instrument panel of claim 1 wherein said nanophosphor particles do not form any visible patterns when UV light is applied and wherein said nanophosphor particles emit visible light in response to said UV light.

4. The instrument panel of claim 1 wherein said nanophosphor particles are not individually visible to the human eye and wherein said nanophosphor particles illuminate said backplate with visible light in response to applied UV light.

5. The instrument panel of claim 4 wherein said nanophosphor particles provide a uniform light to said backplate.

6. The instrument panel of claim 1 wherein said substrate including said nanophosphor particles is substantially transparent.

7. The instrument panel of claim 1 wherein nanophosphor particles do not substantially change the optical transmission of the substrate.

8. The instrument panel of claim 1 wherein said substrate is substantially clear.

9. The instrument panel of claim 1 wherein said backplate includes visible indicia and wherein said substrate applied to said backplate substantially does not distort said visible indicia.

10. The instrument panel of claim 1 wherein said substrate is a film.

11. The instrument panel of claim 10 wherein said nanophosphor particles are embedded in said film.

12. The instrument panel of claim 11 wherein said nanophosphor particles are applied to the surface of said film.

13. The instrument panel of claim 1 wherein said nanophosphor particles are approximately less than 400 nm in diameter.

14. The instrument panel of claim 14 wherein said nanophosphor particles are spaced an average distance apart that is greater than said diameter of said nanophosphor particle.

15. An instrument panel comprising:
a display having a display surface;
a substrate applied to said display surface and wherein said substrate includes nanophosphor particles that illuminate said display surface in response to applied UV light; and
a UV light source.

16. The instrument panel of claim 15 wherein said nanophosphor particles form less than 50% the volume of said substrate.

17. An instrument panel comprising:
a backplate having a background display surface and gauges;
a substrate applied to said backplate and wherein said substrate includes a first group of nanophosphor particles and a second group of nanophosphor particles and wherein said first and second groups illuminate said backplate with visible light in response to different wavelengths of UV light and wherein said first and second groups illuminate with different visible light colors.

18. The instrument panel of claim 17 wherein said first group of nanophosphor particles are arranged in said substrate above said gauges and said second group of nanophosphor particles are arranged above said background display surface.

19. The instrument panel of claim 17 further including an electronic display and wherein said substrate is applied to the display surface of said electronic display and wherein said nanophosphor particles illuminate said display surface with a shade of white light in response to applied UV light.

20. The instrument panel of claim 17 wherein said nanophosphor particles form less than 50% by volume of said substrate.
